(19) United States
(12) Patent Application Publication
(10) Pub. No.: US 2021/0326989 A1
(43) Pub. Date: Oct. 21, 2021

(54) DETERMINATION OF INSURABILITY AFTER A NATURAL DISASTER

(71) Applicant: STATE FARM MUTUAL AUTOMOBILE INSURANCE COMPANY, Bloomington, IL (US)

(72) Inventors: Kenneth Whitaker, Bloomington, IL (US); John Anthony Argenziano, Bloomington, IL (US); Christopher Holman, Bloomington, IL (US); Mark Durbin, Bloomington, IL (US); Christopher Zimmer, Bloomington, IL (US)

(21) Appl. No.: 14/814,599

(22) Filed: Jul. 31, 2015

Related U.S. Application Data
(60) Provisional application No. 62/082,439, filed on Nov. 20, 2014.

(51) Int. Cl. G06Q 40/08

(52) U.S. Cl. CPC G06Q 40/08

(57) ABSTRACT

In a computer-implemented method, disaster location data indicating a location (e.g., latitude and longitude) of a natural disaster may be received, and a location (e.g., latitude and longitude) of a risk (such as a property or home) may be determined. A distance between the location of the natural disaster and the location of the risk may be calculated. It may be determined that the risk is, or is not, insurable at least in part by comparing the calculated distance to a threshold distance. In response to determining that the property is, or is not, insurable, a user interface may be caused to provide an indication that the risk is, or is not, insurable, respectively. When a property is determined to be insurable, the method may facilitate providing property insurance covering properties that otherwise would not be eligible or qualify for insurance as a result of the natural disaster.

### CROSS-REFERENCE TO RELATED APPLICATION

This claims the benefit of U.S. Provisional Patent Application No. 62/082,439, entitled “Determination of Insurability After a Natural Disaster” and filed on Nov. 20, 2014, the disclosure of which is hereby incorporated herein by reference in its entirety.

### FIELD OF THE DISCLOSURE

The present disclosure generally relates to insurance and, more specifically, to systems and methods for determining insurability following a natural disaster (e.g., during an earthquake moratorium).

### BACKGROUND

Natural disasters such as earthquakes may pose a high risk of damage to homes and other properties over a wide geographic area, and for a significant amount of time following the occurrence of the natural disaster (e.g., due to the integrity of structures having been degraded, or aftershocks of an earthquake, etc.). In the case of earthquakes, to ensure that individuals do not wait until an event has already occurred before purchasing insurance to protect against such a risk, insurance providers may impose a moratorium in which individuals relatively close to the epicenter of the earthquake are not permitted to buy and/or expand insurance coverage for a property/risk within a certain time frame. For example, the moratorium guidelines may specify that homeowners with homes located within a 100 mile radius of the earthquake epicenter are ineligible for insurance coverage for 30 days.

Currently, the county or zip code in which a home is located is used as a rough proxy to determine whether the home is eligible for coverage under the moratorium, with all homes located in a county or zip code straddling the moratorium border being considered ineligible. Given the irregular, widely varying territories associated with different counties and zip codes, this approximation may cause a large number of homes located outside of the specified moratorium radius (e.g., further than 100 miles from the epicenter) to be considered ineligible for coverage. As a result, the insurance provider may lose out on new business from customers who desire to insure risks that, according to the moratorium guidelines, should be acceptably low.

### BRIEF SUMMARY

The present embodiments may, inter alia, enable an insurance provider making an insurability decision (e.g., at the point of sale) to more precisely determine whether a particular property/risk is within a threshold distance of a natural disaster (e.g., a minimum distance from an earthquake epicenter as specified by an earthquake moratorium). As a result, the insurance provider may be able to insure at least a portion of the homes or other properties located within counties or zip codes that straddle a moratorium boundary, even while the moratorium is still in effect.

In one aspect, a computer-implemented method may include (1) receiving, by one or more processors (such as via wired or wireless communication or data transmission), disaster location data indicating a location of a natural disaster; (2) determining, by the one or more processors, a location of a risk (such as a location of a property or home that the owner desires to insure); (3) calculating, by the one or more processors, a distance between the location of the natural disaster and the location of the risk (and/or property); (4) determining, by the one or more processors, that the risk (and/or property) is, or is not, insurable at least in part by comparing the calculated distance to a threshold distance; and/or, (5) in response to determining that the risk (and/or property) is, or is not, insurable, causing, by the one or more processors, a user interface to provide an indication that the risk (and/or property) is, or is not, insurable, respectively (such as via wired or wireless communication or data transmission that is under the direction or control of the one or more processors and is sent to a computing device having a display screen that is associated with the user interface). The computer-implemented method may include additional, fewer, or alternate actions, such as any of those discussed elsewhere herein.

In another aspect, a tangible, non-transitory computer-readable medium stores instructions that may, when executed by one or more processors, cause the one or more processors to (1) receive disaster location data indicating a location of a natural disaster; (2) determine a location of a risk (such as a location of a property or home); (3) calculate a distance between the location of the natural disaster and the location of the risk; (4) determine whether the risk (and/or property) is insurable at least in part by comparing the calculated distance to a threshold distance; and/or, (5) when determining that the risk (and/or property) is not insurable, cause a user interface to provide an indication that the risk (and/or property) is not insurable (or not currently insurable), and/or when determining that the risk (and/or property) is insurable, cause the user interface to provide an indication that the risk (and/or property) is insurable. The non-transitory computer-readable medium may store instructions that direct the one or more processors to perform additional, less or alternative functionality, such as any of the functionality discussed elsewhere herein.

In another aspect, a computer-implemented method may include (1) determining, by one or more processors, that an earthquake moratorium is in effect; (2) receiving, by the one or more processors, such as via wired or wireless communication, earthquake location data indicating a latitude and longitude of an epicenter of an earthquake; (3) determining, by the one or more processors, a latitude and longitude of a property of a current or potential customer; (4) calculating, by the one or more processors, a distance between the latitude and longitude of the epicenter and the latitude and longitude of the property; (5) determining, by the one or more processors, whether or not the property is insurable at least in part by comparing the calculated distance to a threshold distance associated with the earthquake moratorium, and/or (6) in response to determining that the property is, or is not, insurable, causing, by the one or more processors, a user interface to provide an indication that the property is, or is not, insurable, respectively (such as via the one or more processors directing or controlling a wired or wireless communication and/or data transmission to be sent or transmitted to a computing device associated with the user interface). As a result, when a property is determined to be insurable, the method may facilitate providing property insurance covering properties that otherwise would not be eligible or qualify for insurance under current conditions. The computer-implemented method may include additional, fewer, or alternate actions, such as any of those discussed elsewhere herein.

### BRIEF DESCRIPTION OF THE DRAWINGS

The Figures described below depict various aspects of the system and methods disclosed therein. It should be understood that each figure depicts an example of a particular aspect of the disclosed system and methods, and that each of the figures is intended to accord with a possible example thereof. Further, wherever possible, the following description refers to the reference numerals included in the following figures, in which features depicted in multiple figures are designated with consistent reference numerals.

There are shown in the drawings arrangements which are presently discussed, it being understood, however, that the present examples are not limited to the precise arrangements and instrumentalities shown, wherein:

FIG. 1 depicts an exemplary environment including components associated with determining insurability after a natural disaster, according to an embodiment;

FIG. 2 depicts a conventional technique for determining insurability after a natural disaster;

FIG. 3 depicts an improved technique for determining insurability after a natural disaster, according to one embodiment and scenario;

FIG. 4 depicts a flow diagram of an exemplary method for determining insurability after a natural disaster, according to an embodiment;

FIG. 5 depicts a flow diagram of an exemplary method for determining insurability after an earthquake while an earthquake moratorium is in effect, according to an embodiment; and

FIG. 6 depicts an exemplary computer system in which the techniques described herein may be implemented, according to an embodiment.

The Figures depict preferred examples for purposes of illustration only. One skilled in the art will readily recognize from the following discussion that alternative examples of the systems and methods illustrated herein may be employed without departing from the principles of the invention described herein.

### DETAILED DESCRIPTION

### I. Exemplary Insurability Determination after a Natural Disaster

The present embodiments relate to determining insurability (e.g., at the “point of sale”) for risks in the vicinity of a recent earthquake or other natural disaster. Insurability may be determined for a home insurance policy or a condominium insurance policy, for example. Alternatively, or additionally, insurability may be determined for any other type of policy that insures against a risk having a magnitude that may be related to proximity to the natural disaster (e.g., auto insurance, life insurance, etc.). As used herein, and unless otherwise required by the context of the usage, the terms “customer” and “policyholder” may be used interchangeably, and may generally refer to either an existing customer or policyholder (e.g., an individual seeking a coverage change) or a potential customer or policyholder (e.g., an individual seeking a quote for a new insurance policy or applying for insurance coverage).

In some embodiments and scenarios, an insurance agent or other insurance provider employee may seek to determine whether a particular risk (e.g., risk of damage to a particular home or other property) is eligible to be insured. To determine insurability, the agent may use a computer terminal, a desktop computer, a laptop computer, a smart phone, a tablet, a phablet, smart watch, smart glasses, smart bracelet, wearable electronics device, smart vehicle controller, any other suitable computing device, and/or any other mobile device configured for wired or wireless communication, along with a software application running on the computing device (e.g., a web browser application for accessing a web page of the insurance provider, or a dedicated software application, etc.). The agent may use the computing device and software application to enter information about the risk to be insured, including a location of the risk (e.g., an address of a home to be insured). The agent may also enter other information, such as the type and level of desired coverage, information about the customer (e.g., demographic information, claim history information, etc.), and so on. Alternatively, some or all of the information may be entered directly by the customer using a mobile or computing device and software application (e.g., by accessing an insurance application web page hosted by the insurance provider).

The entered information may be submitted to a server (or other computing system) of the insurance provider. Alternatively, the server may retrieve some or all of the information from records already maintained by the insurance provider (e.g., if the customer is an existing policyholder looking to purchase a higher level of coverage) and/or already maintained by a third party. In either case, the server may also determine a location (e.g., a latitude and longitude) associated with a natural disaster, such as an earthquake, hurricane, tornado, etc. For example, the location may be the epicenter of a recent earthquake, or a recent or projected location of a hurricane, etc. The “location” may be a single point (e.g., at the earthquake epicenter), or may be a path or area (e.g., a projected path of a hurricane, or an area extending across a range of potential hurricane paths, etc.). The server may retrieve the location of the natural disaster from a memory, where the location may have been stored after being requested from a server associated with the United States Geological Survey (USGS) or another entity. Alternatively, the location may have been stored in the memory after an insurance provider employee looked up and entered the location, or after one or more other automated and/or manual actions were taken to learn the location information.

The server may use the risk location information and the location of the natural disaster to determine a distance between the risk location and the natural disaster location. In some embodiments and/or scenarios, this determination may involve translating one or both of the locations to a different type of location information. For example, to calculate the distance between the risk location and a known latitude and longitude of the natural disaster location, the server may need to translate a home address included in the risk location information to a latitude and longitude. The server may accomplish the translation in any suitable manner, such as accessing insurance provider records or third party (e.g., government) records to determine the latitude and longitude of the home address, for example. Alternatively, the risk location information originally obtained by the server may already be of the same type/format as the natural disaster location.

The server may then compare the distance between the risk location and the natural disaster location to a threshold distance. For example, the server may compare the calculated distance to a minimum distance specified by a set of moratorium guidelines corresponding to the natural disaster (e.g., 10 miles, 100 miles, 200 miles, etc.). If the calculated distance is not greater than the threshold distance, the server may flag the risk as being ineligible for coverage (e.g., for the duration of a moratorium). Conversely, if the calculated distance is greater than the threshold distance, the server may either flag the risk as being eligible for coverage (e.g., in an embodiment and/or scenario where it has already been determined that other eligibility requirements, if any, are satisfied), or flag the risk as being potentially eligible for coverage (e.g., in an embodiment and/or scenario where other eligibility requirements remain to be checked).

The outcome of the determination of eligibility may then be presented to the agent, other insurance provider employee, and/or customer. If the agent, customer or other individual used a dedicated software application, or accessed a web page of the insurance provider, to enter the location of the risk, the same dedicated software application or the same web page (or a different web page also maintained by the insurance provider) may present the result to that individual, for example. In some embodiments, a determination that the risk is insurable does not directly result in any display to the agent, customer or other individual. For example, an application and/or premium quoting process may simply continue (e.g., a quote may be determined and/or displayed, other insurability requirements may be checked, home features may be retrieved or received via wired or wireless communication, etc.).

In an alternative embodiment, all of the server processing operations described above may instead be performed at the mobile device (e.g., smart phone, laptop, tablet, etc.) or other computing device of the agent (or other insurance provider employee, or customer, etc.). For example, an agent's smart phone or tablet may obtain the natural disaster location directly from the USGS (or from the insurance provider server, etc.), obtain the risk location based upon information entered by the agent, calculate the distance between the risk and natural disaster locations, and/or provide indication of coverage eligibility to the agent.

In another alternative embodiment, insurability may not be determined in a binary manner. For example, the distance between the risk location and the natural disaster location may be compared to a set of distance ranges (e.g., “0 through 25 miles,” “25-50 miles,” “50-100 miles” and “greater than 100 miles”), and a risk category (e.g., A, B, C or D) may be assigned based upon the matching range. Thereafter, the risk category may be used to determine which types of coverage are available, to determine which levels of coverage (e.g., deductibles and/or limits) are available, to determine cost of coverage, and/or to determine other coverage parameters and/or options.

Using a more precise calculation of distance between a risk location and a natural disaster location as described herein may provide one or more benefits. For example, the insurance provider may more closely/accurately adhere to the risk tradeoffs reflected in a set of moratorium guidelines. As another example, the insurance provider may obtain new business (e.g., new policyholders, and/or additional coverage for existing policyholders) that would otherwise be unavailable if using conventional techniques such as approximating distance by county or zip code.

### II. Exemplary Environment for Determining Insurability

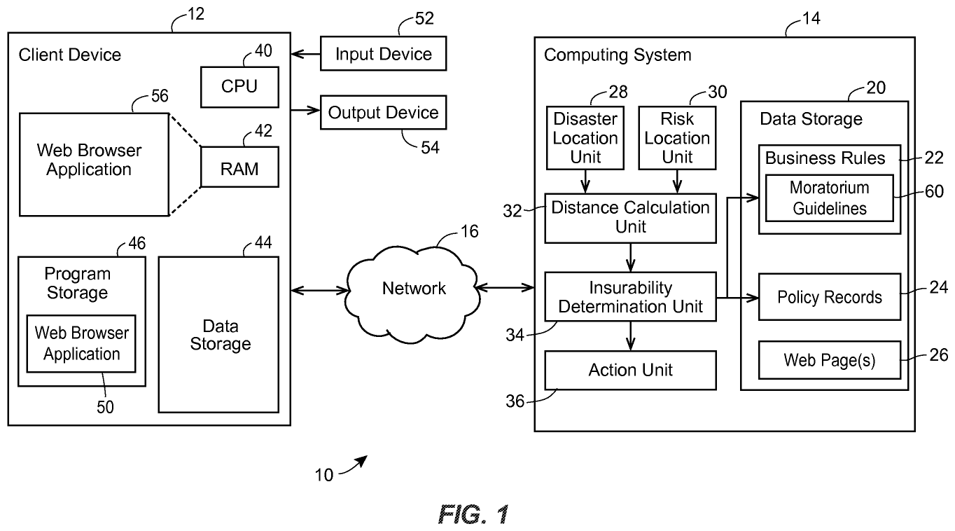

FIG. 1 depicts an exemplary environment 10 in which it may be determined whether a risk is insurable, according to an embodiment. As illustrated in FIG. 1, the environment 10 may include a client device 12 and a computing system 14. The computing system 14 may include one or more servers of an insurance provider, such as an insurance company providing home and/or condominium insurance, for example. The user of client device 12 may be an agent or other employee of the insurance provider, for example. Alternatively, the user of client device 12 may be a customer of the insurance provider. For ease of explanation, however, FIG. 1 will be described with reference to an embodiment in which the user is an insurance agent. In the exemplary environment 10, computing system 14 is communicatively coupled to client device 12 via a network 16. Network 16 may be a single communication network, or may include multiple communication networks of one or more types (e.g., one or more wired and/or wireless local area networks (LANs), and/or one or more wired and/or wireless wide area networks (WANs) such as the Internet). The environment 10 may include additional, fewer or alternate components as compared to those shown in FIG. 1, such as any of those discussed elsewhere herein, for example.

Computing system 14 may include a data storage 20, which may include one or more types of persistent memory. Data storage 20 may store business rules 22, policy records 24 and one or more web pages 26. The business rules 22 may specify policies and/or processes of the insurance provider for determining whether a particular risk is insurable, and possibly one or more other types of rules (e.g., rules specifying which coverage types and/or levels are available, rules for calculating premiums based upon coverage types/levels, risk types and/or policyholder information, etc.). The policy records 24 may contain policyholder information for customers having existing policies, and/or policyholder information for customers who do not yet have existing policies but have entered the information (e.g., in order to obtain a premium quote). The policyholder information may include, for each customer, personal/demographic information such as gender, birth date, etc., of the customer, and/or information about property of the customer (e.g., information about the property to be insured, such as the address, estimated value, construction type, features, etc., of a home). The web page(s) 26 may provide information and/or tools to the agent as described further below, and may include HyperText Markup Language (HTML) instructions, JavaScript instructions, JavaServer Pages (JSP) instructions and/or any other type of instructions suitable for defining the content and presentation of the web page(s) 26.

In the exemplary environment 10, computing system 14 may also include a disaster location unit 28, a risk location unit 30, a distance calculation unit 32, an insurability determination unit 34, and an action unit 36. Generally, in an embodiment, disaster location unit 28 determines a location associated with a natural disaster, risk location unit 30 determines the location of a risk (e.g., a location of a home to be insured), distance calculation unit 32 calculates the distance between the natural disaster location and the risk location, insurability determination unit 34 uses the calculated distance to determine whether the risk is insurable, and action unit 36 takes some action (e.g., notifying the agent) based upon the insurability determination. The operation of units 28, 30, 32, 34 and 36 will be described in more detail below. In some embodiments, each of units 28, 30, 32, 34 and 36 is (or includes) a respective set of one or more processors that executes software instructions to perform the functions described below, or the units 28, 30, 32, 34 and/or 36 may share one or more processors. Alternatively, each of some or all of the units 28, 30, 32, 34 and 36 may be a component of software that is stored on a computer-readable medium (e.g., a random access memory (RAM) and/or ROM of computing system 14), and is executed by one or more processors of the computing system 14 to perform the functions described below.

While many agents/client devices may be communicatively coupled to computing device 14 (e.g., for access to web page(s) 26), for clarity FIG. 1 illustrates only the client device 12 of a single agent. As illustrated in FIG. 1, client device 12 may include a central processing unit (CPU) 40 to execute computer-readable instructions, a RAM 42 to store data and instructions during operation of programs, a data storage 44 that includes persistent memory to store data used by the programs executed by CPU 40, and a program storage 46 that includes persistent memory to store the programs executed by CPU 40. Program storage 46 may include a web browser application 50, for example. By way of example, the data storage 44 and/or the program storage 46 may be implemented on a hard disk drive coupled to CPU 40 via a bus (not shown in FIG. 1). More generally, the components 40, 42, 44 and 46 may be implemented in any suitable manner according to known techniques. Client device 12 may be a personal computer (e.g., desktop, laptop, notebook), any other suitable stationary or portable computing device, and/or any mobile device, such as a tablet, phablet, laptop, smartphone, smart glasses, smart watch, or wearable electronics, for example.

While client device 12 in the example of FIG. 1 may include both storage and processing components, client device 12 may instead be a so-called “thin” client that depends upon another computing device for certain computing and/or storage functions. For example, data storage 44 and/or program storage 46 may be external to client device 12 and connected to client device 12 via a network link. In some embodiments, client device 12 may be a terminal of the computing system 14, and program storage may not include web browser application 50.

Further, client device 12 may be coupled to an input device 52 that allows the agent to enter inputs to client device 12, and an output device 54 that allows the agent to view outputs/displays generated by client device 12. The input device 52 may be a pointing device such as a mouse, keyboard, trackball device, digitizing tablet or microphone, for example. The output device 54 may be a display monitor, for example. In one embodiment, input device 52 and output device 54 may be integrated as parts of a single device (e.g., a touch screen device). Using the input device 52 and the output device 54, the agent may be able to interact with graphical user interfaces (GUIs) provided by the client device 12.

When CPU 40 executes the web browser application 50, RAM 42 may temporarily store the instructions and data required for its execution. In FIG. 1, for example, the web browser application 50 being executed is represented in the program space of RAM 42 as web browser application 56.

In operation, the agent may use client device 12 to find out whether, based upon the proximity of a particular risk to the occurrence of a natural disaster (e.g., proximity of the customer's home to the natural disaster location), the insurance provider can or will provide insurance coverage for the risk. The agent may be inquiring into insurability in response to an application from the customer, for example, or may be proactively determining insurability in advance of soliciting the customer to offer insurance products. Using the web browser application 56, the agent may access web page(s) 26 of computing system 14, and navigate, and/or select (e.g., click on) a reference to, a page providing a tool for determining insurability. The page/tool may allow the agent to enter, and submit to computing system 14, various kinds of information that may be pertinent to the insurability determination, such as information about the risk itself (e.g., information about a home or other property to be insured), the type and/or level of desired coverage, information about the customer (e.g., demographic information, claim history information, etc.), and so on. The agent may enter the information using input device 52, for example.

The information submitted to computing system 14 via one or more of web page(s) 26 may include a location of the risk to be insured, such as a home address, for example. Risk location unit 30 may receive the location information, and use/process the information to determine a latitude and longitude of the risk. For example, risk location unit 30 may cross-reference a received home address against latitude and longitude information stored in policy records 24 (e.g., if the customer is an existing or former policyholder, or if the latitude and longitude information has previously been obtained by other means). Alternatively, risk location unit 30 may determine the latitude and longitude of the home address using a mapping service or application (e.g., a third party mapping service), or in any other suitable manner. In still other embodiments and/or scenarios, the latitude and longitude of the risk location may already have been included in the information received from client device 12, and the risk location unit 30 need not translate to latitude and longitude coordinates. For example, a navigational/GPS application running on the agent's smart phone (or other mobile device) may have determined a latitude and longitude for the customer's home at a time when the agent was visiting the customer at his or her home.

To determine a location of the natural disaster, disaster location unit 28 may retrieve the location of the natural disaster from a memory (e.g., data storage 20). For example, the computing system 14 may have stored the location in the memory after requesting the location from a USGS server, after the agent or another insurance provider employee looked up and entered the location, or after one or more other automated or manual actions were taken to learn the location information. The location information may have been obtained, and/or stored in the memory, either before or after the agent's inquiry. Alternatively, the location of the natural disaster may be entered by the agent when accessing web page(s) 26, and submitted to computing system 14 for processing at disaster location unit 28. The determined “location” of the natural disaster may be a single point, or may be a path or area. For example, disaster location unit 28 may determine a latitude and longitude of the epicenter of a recent earthquake, a set of latitudes and longitudes of an actual and/or projected path of a hurricane, a set of latitudes and longitudes defining a border around an area reflecting a number of different potential paths of a hurricane, etc.

Once latitude and longitude coordinates have been determined for both the natural disaster (e.g., earthquake epicenter) and the risk (e.g., home), distance calculation unit 32 may calculate a distance between the two sets of coordinates (e.g., using well-known trigonometric formulas for calculating distance between latitude/longitude pairs). Distance calculation unit 32 may then provide the calculated distance to insurability determination unit 34, which may use the distance to determine whether the risk is eligible for insurance coverage. To determine eligibility/insurability, distance calculation unit 32 may compare the calculated distance to a threshold distance. For example, distance calculation unit 32 may compare the calculated distance to a minimum distance specified by moratorium guidelines 60 included in business rules 22.

To provide a more specific example, the moratorium guidelines 60 may specify that no new insurance coverage should be provided for any homes and/or other properties located within 100 miles of the epicenter of an earthquake. The moratorium guidelines 60 may also indicate a duration (e.g., 30 days) and/or an expiration date of the moratorium. In some embodiments, the computing system 14 checks whether the moratorium is still in effect (e.g., by comparing an expiration date against the current date, or by checking a flag value, etc.), and only utilizes units 28, 30, 32, 34 and/or 36 if the moratorium is still in effect. The moratorium guidelines 60 may include rules that are generally applicable to multiple occurrences of a natural disaster, and/or may include rules that were developed specifically for the natural disaster that gave rise to the current moratorium.

Insurability determination unit 34 may generate an indicator (e.g., a flag or other data) indicating whether the calculated distance is greater than the threshold distance specified by the moratorium guidelines 60, and pass the indicator to action unit 36. Depending upon the value of the indicator, action unit 36 may perform various different actions in different embodiments. If the indicator shows that the calculated distance is greater than the threshold distance, for example, action unit 36 may cause the web browser application 56 of client device 12 to show a message or other indication that the risk is insurable, and/or may cause the computing system 14 to proceed to check other eligibility requirements, if any, that are specified business rules 22. As another example, action unit 36 may simply cause an insurance application (and/or premium quote) process to continue, without providing an insurance eligibility message.

Conversely, if the indicator shows that the calculated distance is less than the threshold distance, action unit 36 may cause the web browser application 56 of client device 12 to show a message or other indication that the risk is not insurable. The indication may be a message related to the reason for ineligibility (e.g., “Due to the recent earthquake in the vicinity of this home, coverage will not be available for X more days”), a more generic message (e.g., “Coverage currently unavailable”), or any other suitable type of indicator (e.g., a checked or unchecked box, etc.).

While FIG. 1 has been described primarily with respect to an embodiment in which an insurance agent uses client device 12 to determine insurability via web browser application 56, other embodiments are also possible. As noted above, for example, a customer may use client device 12 to access web page(s) 26 to enter information and/or view the indication of insurability. As another example, the user of client device 12 (e.g., an agent, a customer, etc.) may use a dedicated software application (e.g., an application, not shown in FIG. 1, that is downloaded from the computing system 14 and stored in program storage 46) to enter information and/or view the indication of insurability, and/or may view the indication of insurability via an email, via a text message, or in any other suitable manner. As still another example, an insurance agent may use client device 12 to determine insurability according to any of the embodiments described above, but with the customer providing some of the information to the computing system 14 (e.g., providing a home address, or home latitude and longitude, to risk location unit 30) via another computing device (e.g., a smart phone, tablet, etc., of the customer). As yet another example, one, some or all of units 28, 30, 32, 34 and 36 may be located in client device 12 (or another computing device) rather than computing system 14. For example, units 28, 30, 32, 34 and/or 36 may be components of a dedicated software application stored and executed on client device 12.

Additionally, or alternatively, insurability determination unit 34 may make a non-binary determination, rather than the “insurable” versus “not insurable” determination described above. For example, insurability determination unit 34 may compare the distance between the risk location and the natural disaster to a set of distance ranges (e.g., “0 through 25 miles,” “25-50 miles,” “50-100 miles” and “greater than 100 miles”), and assign a risk category (e.g., A, B, C or D) based upon the matching range. Thereafter, insurability determination unit 34 (or another unit not shown in FIG. 1) may use the risk category to determine which types of coverage are available, to determine which levels of coverage (e.g., deductibles and/or limits) are available, to determine cost of coverage, and/or to determine other coverage parameters and/or options. The distance ranges for each category, and/or the applicable coverage parameters and/or coverage options for each range, may be specified by the business rules 22, for example. Insurability determination unit 34 may generate an indicator of the coverage parameters and/or coverage options corresponding to the matching distance range, and pass the indicator to action unit 36, which may cause an indication of the coverage parameters and/or coverage options to be displayed to the agent (or customer or other individual), and/or may cause some other action to be initiated (e.g., continuing to check other eligibility requirements, calculating a premium quote, etc.), for example.

As can be seen from the above discussion, the components in the environment 10, when using the above techniques, may drastically shorten the time required to complete an insurance process, such as the time from initial loan application submission to loan approval, at least in part by quickly and precisely determining insurance eligibility. As such, the resource usage or consumption of the components in the environment 10 (e.g., in the computing system 14 and/or the client device 12) during the loan approval process for the loan applicant may be greatly reduced. For example, the number of processor cycles utilized by the computing system 14 and/or the client device 12 from initial loan application submission to loan approval may be greatly reduced. Further, as there may be no need to store an indication of all counties and/or zip codes that are subject to a particular moratorium, the amount of data storage required (e.g., at the data storage 20) to service the loan applicant may also be greatly reduced.

### III. Conventional Technique for Determining Insurability

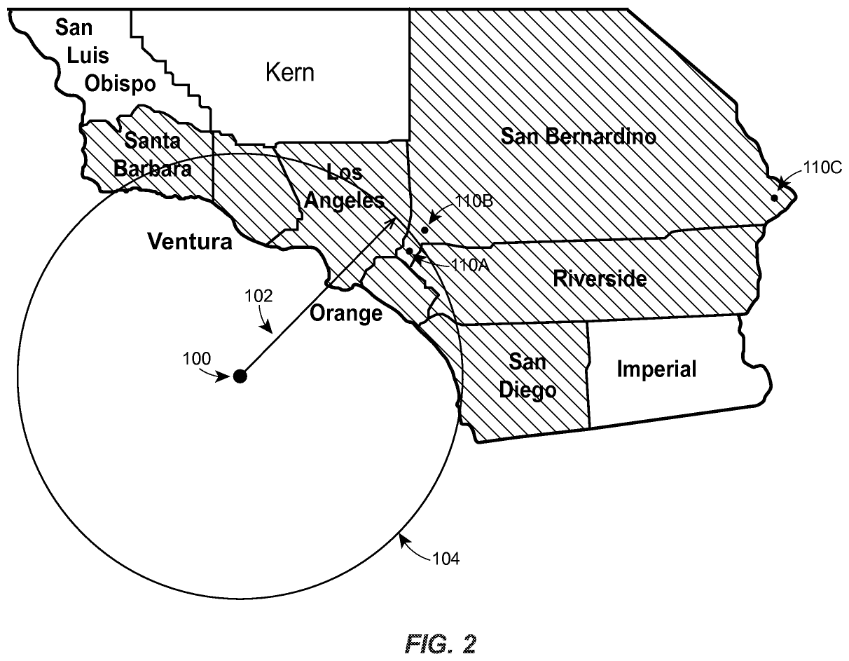

For purposes of comparison, FIG. 2 depicts a conventional technique for determining insurability after a natural disaster. In the example scenario of FIG. 2, an earthquake epicenter has a location 100 that is in the Pacific Ocean off the coast of southern California. FIG. 2 also corresponds to a scenario in which the guidelines of a moratorium specify a threshold distance 102 as the minimum distance that a home must be from the epicenter location 100 in order to be eligible for new insurance coverage. The threshold distance 102 creates a circular boundary 104, which in theory delimits the area in which homes cannot be newly insured, and in which coverage limits cannot be increased on homes. When using a conventional technique in which a home's county is used as a proxy for distance, however, an insurance provider will determine that a given home is not eligible for new insurance coverage during the moratorium if any portion of the home's county is within the threshold distance 102 of the epicenter location 100 (i.e., if any portion is within the boundary 104). Thus, as seen by the shading included in FIG. 2, homes located anywhere within Santa Barbara County, Ventura County, Los Angeles County, San Bernardino County, Orange County, Riverside County and San Diego County will not be eligible for new insurance coverage. For example, homes at locations 110A, 110B and 110C in San Bernardino County would all be considered ineligible for the duration of the moratorium.

While this result aligns with the moratorium guidelines with respect to the home at location 110A, the homes at location 110B and 110C are considered ineligible despite being outside the moratorium boundary 104. Thus, the homes at locations 110B and 110C, and a very large number of other homes in those areas of Santa Barbara County, Ventura County, Los Angeles County, San Bernardino County, Riverside County and San Diego County that are outside of the boundary 104, will, during the moratorium, unnecessarily be removed from the pool of potential new customers (or from the pool of existing customers potentially increasing their coverage levels). The insurance provider therefore misses out on those areas of potential revenue, and homeowners seeking to purchase or expand insurance coverage during the moratorium may be frustrated by their inability to do so.

### IV. Improved Technique for Determining Insurability

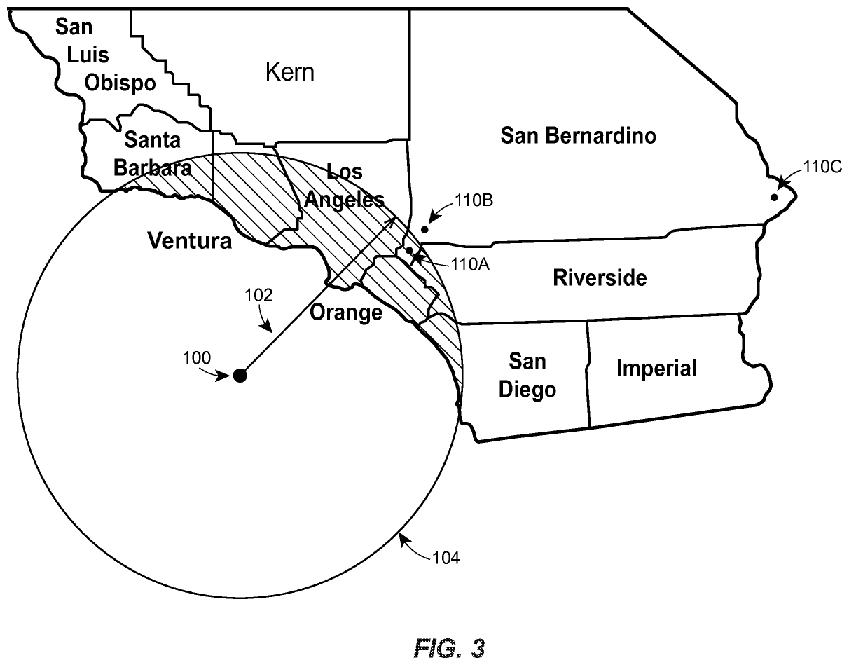

FIG. 3 corresponds to the scenario of FIG. 2, but depicts an improved technique for determining insurability after a natural disaster, according to an embodiment. In FIG. 3, latitude and longitude may be determined not only for the epicenter location 100, but also for the home location, and the distance between the two locations may be calculated. With reference to FIG. 1, for example, disaster location unit 28 may determine the latitude and longitude coordinates of epicenter location 100, risk location unit 30 may determine the latitude and longitude coordinates of the home location, distance calculation unit 32 may calculate the distance between epicenter location 100 and the home location, and insurability determination unit 34 may determine that the home is not (or alternatively is) insurable if the home location is within (or outside of, respectively) the threshold distance 102 (e.g., 100 miles) of the epicenter location 100.

Using this technique, the area in which homes cannot be newly insured, and/or in which coverage levels cannot be increased on homes, matches (or at least, better matches) the moratorium boundary 104, as seen by the shaded area in FIG. 3. For example, homes 110B and 110C may now be eligible for new or increased insurance coverage (e.g., if any other insurability requirements are satisfied), despite being within a county (San Bernardino County) that is partially within the moratorium boundary 104. As a result, the insurance provider may capture some revenue from policies that otherwise could not have been approved or issued until a later time.

### V. Exemplary Process Flow for Determining Insurability after a Natural Disaster

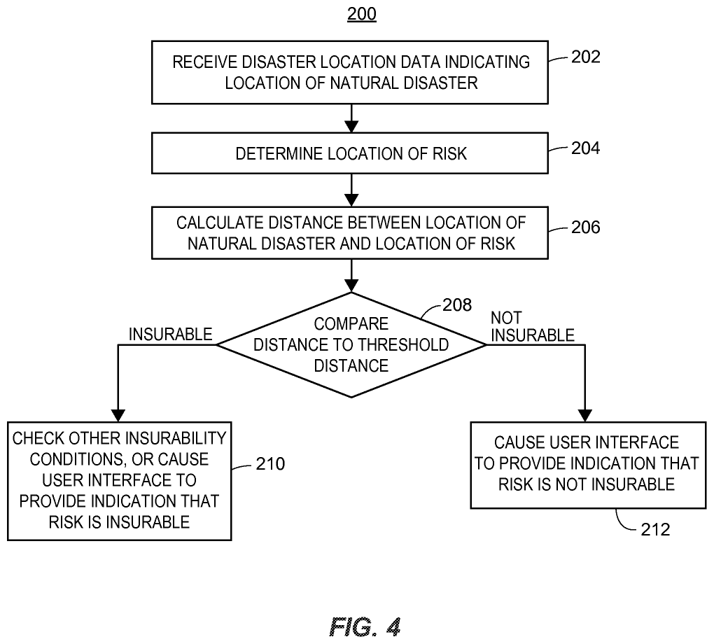

FIG. 4 depicts a flow diagram of an exemplary method 200 for determining insurability after a natural disaster, according to an embodiment. The method 200 may be implemented in (e.g., performed by one or more processors of) a server or other computer device of an insurance provider's computing system, such as a server or other computer device within computing system 14 of FIG. 1, for example. Alternatively, some of all of the method 200 may be implemented in (e.g., performed by one or more processors of) a computing device of an insurance agent, customer or other individual, such as client device 12 of FIG. 1, for example.

In the method 200, disaster location data indicating a location of a natural disaster may be received (block 202). The natural disaster may be an earthquake, hurricane, tornado, wild fire, or any other type of natural disaster, and the location may be a point location (e.g., a single latitude/longitude pair), one or more paths (e.g., as defined by a set of latitude and longitude coordinates), or an area (e.g., as defined by a boundary, with the boundary being defined by a set of latitude and longitude coordinates), for example. The disaster location data may be received various different ways, according to different embodiments. For example, the data may be received from a database or server of the insurance provider, from a third party (e.g., a USGS) server, or from an insurance agent or other user of a computing device after having been entered via a user interface and/or submitted via a network. In one embodiment, block 202 may be performed by a unit similar to disaster location unit 28 of FIG. 1.

A location of a risk may be determined (block 204). The location may be the latitude and longitude of a home or other property, for example. The location may be determined in various different ways, according to different embodiments. For example, a latitude and longitude of the risk may be received from a database or server of the insurance provider, or from an insurance agent or other user of a computing device after having been entered via a user interface (or automatically determined using a navigational application) and/or submitted via a network. As another example, block 204 may include receiving application data associated with a request for insurance coverage, where the application data includes an address of a property (e.g., a home address). The address may then be used to determine the latitude and longitude (e.g., by cross-referencing the address with latitudes and longitudes of addresses as indicated in a database). In one embodiment, block 204 may be performed by a unit similar to risk location unit 30 of FIG. 1.

Once the location of the natural disaster and the location of the risk are known, a distance between the two locations may be calculated (block 206). If each of the locations is a single set of latitude and longitude coordinates, for example, conventional mathematical techniques for determining distances between latitude/longitude pairs may be used to determine the distance between the two coordinate sets. As another example, if the natural disaster location includes multiple coordinates (e.g., multiple latitude and longitude coordinates), distances between the risk coordinates and each of the multiple natural disaster coordinates may be calculated using conventional mathematical techniques for determining distances between latitude/longitude pairs, and a minimum of the distances may then be selected as the distance calculated at block 206. In one embodiment, block 206 may be performed by a unit similar to distance calculation unit 32 of FIG. 1.

To determine whether the risk is insurable, the calculated distance may be compared to a threshold distance (block 208). For example, it may be determined that the risk is not insurable if the calculated distance is not greater than the threshold distance, or that the risk is insurable if the calculated distance is greater than the threshold distance. In some embodiments, a positive determination of insurability includes making one or more additional determinations, such as whether the customer's claim history disallows coverage, etc. In one embodiment, block 208 may be performed by a unit similar to insurability determination unit 34 of FIG. 1.

If it is determined at block 208 that the risk is insurable (or potentially insurable), other insurability conditions (and/or property or home features or characteristics) may be checked, and/or (e.g., if there are no other conditions, or if any other conditions have already been checked) a user interface may be caused to provide an indication that the risk is insurable (block 210). The indication may be sent (e.g., via one or more wired and/or wireless networks) to a computer device associated with a customer, and/or to a computer device associated with an insurance agent, for example, where the insurability of the risk may be indicated on the user interface. The user interface may be an email user interface, a text message user interface, an interactive web page, a GUI (Graphical User Interface) provided by a software application, or any other suitable type of user interface. Insurability may be indicated by a message stating that the risk is insurable, or may be indicated implicitly by virtue of proceeding with an application process, for example. In one embodiment, block 210 may be performed by a unit similar to action unit 36 of FIG. 1.

Conversely, if it is determined at block 208 that the risk is not insurable, the user interface may be caused to provide an indication that the risk is not insurable (block 212). The indication may be sent (e.g., via one or more wired and/or wireless networks) to a computer device associated with a customer, and/or to a computer device associated with an insurance agent, for example, where the (lack of) insurability of the risk may be indicated on the user interface. The user interface may be an email user interface, a text message user interface, an interactive web page, a GUI provided by a software application, or any other suitable type of user interface. The reason for the lack of insurability may be indicated by a message stating why the risk is not insurable (e.g., “Moratorium in effect: Home not eligible for insurance for 24 more days”), or a more general indication may be provided (e.g., “Ineligible”), for example. In one embodiment, block 212 may be performed by a unit similar to action unit 36 of FIG. 1.

It is noted that the blocks of method 200 need not be performed in the order shown in FIG. 4. In various different embodiments and/or scenarios, for example, block 204 may occur before, after or simultaneously with block 202. Also, the method 200 may include additional, fewer, or alternate actions, including those discussed elsewhere herein.

### VI. Exemplary Process Flow for Determining Insurability after an Earthquake

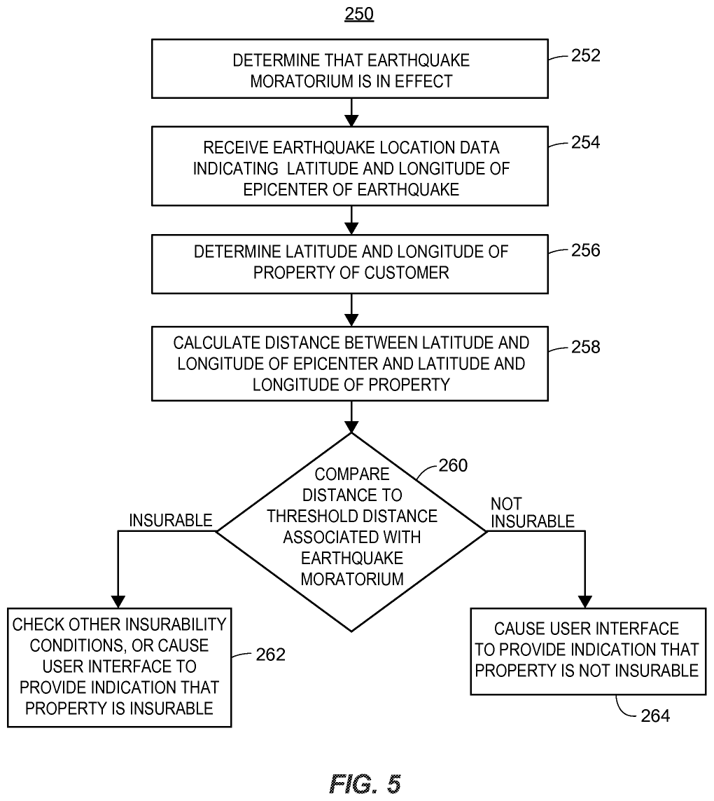

FIG. 5 depicts a flow diagram of an exemplary method 250, which corresponds to a more specific embodiment and/or scenario where insurability is determined after an earthquake occurs and while an earthquake moratorium is still in effect. The method 250 may be implemented in (e.g., performed by one or more processors of) a server or other computer device of an insurance provider's computing system, such as a server or other computer device within computing system 14 of FIG. 1, for example. Alternatively, some of all of the method 250 may be implemented in (e.g., performed by one or more processors of) a computing device of an insurance agent, customer or other individual, such as client device 12 of FIG. 1, for example.

In the method 250, it may be determined that an earthquake moratorium is in effect (block 252). For example, the state of a data flag may be checked to determine whether there is, or is not, a moratorium in effect. In one embodiment, block 250 may be performed by a unit similar to disaster location unit 28 of FIG. 1.

Earthquake location data indicating the latitude and longitude of the epicenter of the earthquake may be received (block 254). The earthquake location data may be received from a remote server (e.g., a USGS server), for example. As another example, the earthquake location data may be received from an insurance agent or other insurance provider employee (e.g., after being entered via a user interface and submitted via a network). In one embodiment, block 254 may be performed by a unit similar to disaster location unit 28 of FIG. 1.

The latitude and longitude of a property (e.g., home) of a customer may be determined (block 256). Block 256 may be similar to block 204 of method 200 in FIG. 4, for example. In one embodiment, block 256 may be performed by a unit similar to risk location unit 30 of FIG. 1.

A distance between the latitude and longitude of the epicenter and the latitude and longitude of the customer's property may be calculated (block 258). Block 258 may be similar to block 206 of method 200 in FIG. 4, for example. In one embodiment, block 258 may be performed by a unit similar to distance calculation unit 32 of FIG. 1.

To determine whether the property is insurable, the calculated distance may be compared to a threshold distance associated with the earthquake moratorium (block 260). The threshold distance may be specified by moratorium guidelines, for example. In one embodiment, block 260 may be performed by a unit similar to insurability determination unit 34 of FIG. 1.

If it is determined at block 260 that the property is insurable (or potentially insurable), other insurability conditions may be checked, and/or (e.g., if there are no other conditions, or if any other conditions have already been checked) a user interface may be caused to provide an indication that the property is insurable (block 262). The indication may be sent (e.g., via one or more wired and/or wireless networks) to a computer device associated with a customer, and/or to a computer device associated with an insurance agent, for example, where the insurability of the property may be indicated on the user interface. The user interface may be an email user interface, a text message user interface, an interactive web page, a GUI provided by a software application, or any other suitable type of user interface. Insurability may be indicated by a message stating that the property is insurable, or may be indicated implicitly by virtue of proceeding with an application process, for example. In one embodiment, block 262 may be performed by a unit similar to action unit 36 of FIG. 1.

Conversely, if it is determined at block 260 that the property is not insurable, a user interface may be caused to provide an indication that the property is not insurable (block 264). The indication may be sent (e.g., via one or more wired and/or wireless networks) to a computer device associated with a customer, and/or to a computer device associated with an insurance agent, for example, where the (lack of) insurability of the property may be indicated on the user interface. The user interface may be an email user interface, a text message user interface, an interactive web page, a GUI provided by a software application, or any other suitable type of user interface. The reason for the lack of insurability may be indicated by a message stating why the property is not insurable (e.g., “Earthquake Moratorium: Home not eligible for insurance for 24 more days”), or a more general indication may be provided (e.g., “Ineligible”), for example. In one embodiment, block 264 may be performed by a unit similar to action unit 36 of FIG. 1.

It is noted that the blocks of method 250 need not be performed in the order shown in FIG. 5. In various different embodiments and/or scenarios, for example, block 254 may occur before, after or simultaneously with block 252, and/or block 256 may occur before, after or simultaneously with block 254 and/or block 252. The method 250 may include additional, fewer, or alternate actions, including those discussed elsewhere herein.

### VII. Exemplary Computer System for Determining Insurability after a Natural Disaster

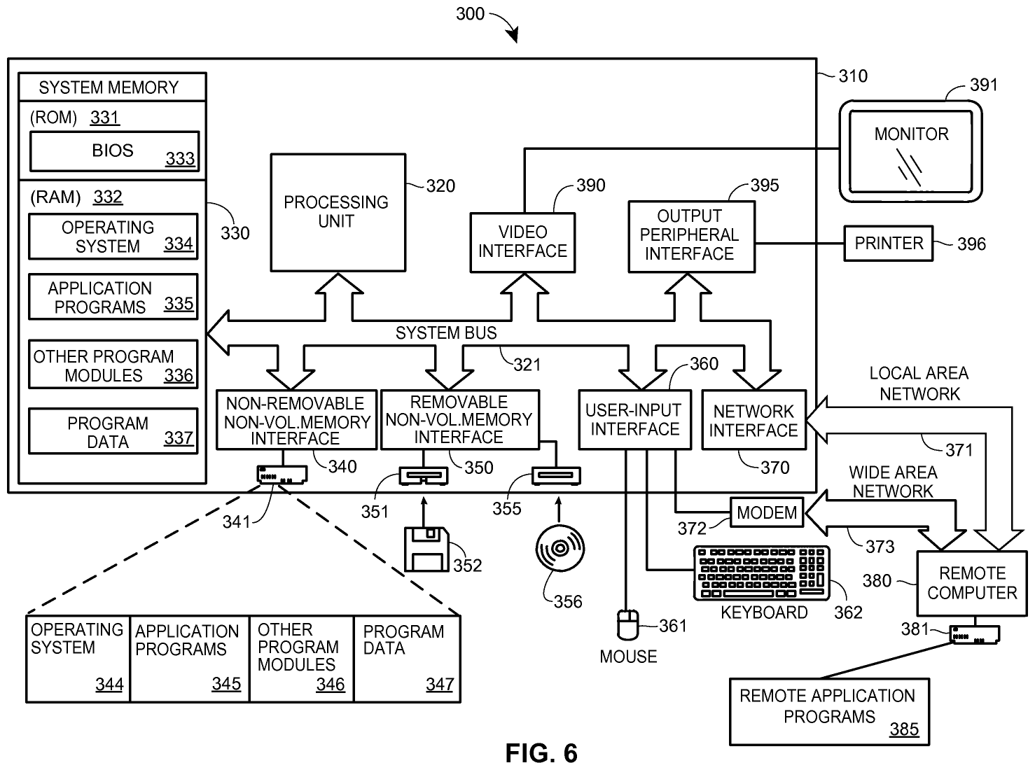

FIG. 6 depicts an exemplary computer system 300 in which the techniques described herein may be implemented, according to an embodiment. The computer system 300 of FIG. 6 may include a computing device in the form of a computer 310. Components of the computer 310 may include, but are not limited to, a processing unit 320, a system memory 330, and a system bus 321 that couples various system components including the system memory 330 to the processing unit 320. The system bus 321 may be any of several types of bus structures including a memory bus or memory controller, a peripheral bus, or a local bus, and may use any suitable bus architecture. By way of example, and not limitation, such architectures include the Industry Standard Architecture (ISA) bus, Micro Channel Architecture (MCA) bus, Enhanced ISA (EISA) bus, Video Electronics Standards Association (VESA) local bus, and Peripheral Component Interconnect (PCI) bus (also known as Mezzanine bus).

Computer 310 typically may include a variety of computer-readable media. Computer-readable media may be any available media that may be accessed by computer 310 and may include both volatile and nonvolatile media, and both removable and non-removable media. By way of example, and not limitation, computer-readable media may comprise computer storage media and communication media. Computer storage media may include volatile and nonvolatile, removable and non-removable media implemented in any method or technology for storage of information such as computer-readable instructions, data structures, program modules or other data. Computer storage media may include, but is not limited to, RAM, ROM, EEPROM, FLASH memory or other memory technology, CD-ROM, digital versatile disks (DVD) or other optical disk storage, magnetic cassettes, magnetic tape, magnetic disk storage or other magnetic storage devices, or any other medium which may be used to store the desired information and which can accessed by computer 310. Communication media typically may embody computer-readable instructions, data structures, program modules or other data in a modulated data signal such as a carrier wave or other transport mechanism, and may include any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, radio frequency (RF), infrared and other wireless media. Combinations of any of the above are also included within the scope of computer-readable media.

The system memory 330 may include computer storage media in the form of volatile and/or nonvolatile memory such as read only memory (ROM) 331 and random access memory (RAM) 332. A basic input/output system 333 (BIOS), containing the basic routines that help to transfer information between elements within computer 310, such as during start-up, may be typically stored in ROM 331. RAM 332 typically may contain data and/or program modules that are immediately accessible to, and/or presently being operated on, by processing unit 320. By way of example, and not limitation, FIG. 6 illustrates operating system 334, application programs 335, other program modules 336, and program data 337.

The computer 310 may also include other removable/non-removable, volatile/nonvolatile computer storage media. By way of example only, FIG. 6 illustrates a hard disk drive 341 that may read from or write to non-removable, nonvolatile magnetic media, a magnetic disk drive 351 that may read from or write to a removable, nonvolatile magnetic disk 352, and an optical disk drive 355 that may read from or write to a removable, nonvolatile optical disk 356 such as a CD ROM or other optical media. Other removable/non-removable, volatile/nonvolatile computer storage media that may be used in the exemplary operating environment include, but are not limited to, magnetic tape cassettes, flash memory cards, digital versatile disks, digital video tape, solid state RAM, solid state ROM, and the like. The hard disk drive 341 may be connected to the system bus 321 through a non-removable memory interface such as interface 340, and magnetic disk drive 351 and optical disk drive 355 may be connected to the system bus 321 by a removable memory interface, such as interface 350.

The drives and their associated computer storage media discussed above and illustrated in FIG. 6 may provide storage of computer-readable instructions, data structures, program modules and other data for the computer 310. In FIG. 6, for example, hard disk drive 341 is illustrated as storing operating system 344, application programs 345, other program modules 346, and program data 347. Note that these components may either be the same as or different from operating system 334, application programs 335, other program modules 336, and program data 337. Operating system 344, application programs 345, other program modules 346, and program data 347 are given different numbers here to illustrate that, at a minimum, they are different copies. A user may enter commands and information into the computer 310 through input devices such as cursor control device 361 (e.g., a mouse, trackball, touch pad, etc.) and keyboard 362. A monitor 391 or other type of display device may also be connected to the system bus 321 via an interface, such as a video interface 390. In addition to the monitor, computers may also include other peripheral output devices such as printer 396, which may be connected through an output peripheral interface 395.

The computer 310 may operate in a networked environment using logical connections to one or more remote computers, such as a remote computer 380. The remote computer 380 may be a personal computer, a server, a router, a network PC, a peer device or other common network node, and typically includes many or all of the elements described above relative to the computer 310, although only a memory storage device 381 has been illustrated in FIG. 6. The logical connections depicted in FIG. 6 include a local area network (LAN) 371 and a wide area network (WAN) 373, but may also include other networks. Such networking environments are commonplace in hospitals, offices, enterprise-wide computer networks, intranets and the Internet.

When used in a LAN networking environment, the computer 310 may be connected to the LAN 371 through a network interface or adapter 370. When used in a WAN networking environment, the computer 310 typically may include a modem 372 or other means for establishing communications over the WAN 373, such as the Internet. The modem 372, which may be internal or external, may be connected to the system bus 321 via the input interface 360, or other appropriate mechanism. The communications connections 370, 372, which allow the device to communicate with other devices, are an example of communication media, as discussed above. In a networked environment, program modules depicted relative to the computer 310, or portions thereof, may be stored in the remote memory storage device 381. By way of example, and not limitation, FIG. 6 illustrates remote application programs 385 as residing on memory device 381.

The techniques for determining insurability described above may be implemented in part or in their entirety within a computer system such as the computer system 300 illustrated in FIG. 6. The computer 310 may be a client device of an insurance agent or customer (e.g., client device 12 of FIG. 1), for example, and the remote computer 380 may be a server device (e.g., within computing system 14 of FIG. 1) including or implementing units 28, 30, 32, 34 and/or 36, for example. Application programs 335 and 345 may include a web browser application (e.g., web browser application 50 of FIG. 1) and/or a dedicated software application as described above in connection with FIG. 1, for example. Remote computer 380 may receive from computer 310 data indicating the risk location, and provide data indicative of insurability back to computer 310, for example.

### VIII. Exemplary Method Embodiments

In one aspect, a computer-implemented method may include (1) receiving, by one or more processors, disaster location data indicating a location of a natural disaster; (2) determining, by one or more processors, a location of a risk (such as a location of a property or home); (3) calculating, by one or more processors, a distance between the location of the natural disaster and the location of the risk; (4) determining, by one or more processors, that the risk is not (or is) insurable at least in part by comparing the calculated distance to a threshold distance; and/or (5) in response to determining that the risk is not (or is) insurable, causing, by one or more processors, a user interface to provide an indication that the risk is not (or is, respectively) insurable.

The computer-implemented method may include one or more of the following features: (1) receiving disaster location data may include receiving earthquake location data indicating an epicenter of an earthquake, such as receiving data indicating a latitude and longitude of the epicenter from a remote server, for example; (2) determining a location of a risk may include determining a latitude and longitude of a location of a property, and calculating a distance between the location of the natural disaster and the location of the risk may include calculating a distance between the location of the epicenter and the location of the property using (i) the latitude and longitude of the location of the epicenter and (ii) the latitude and longitude of the location of the property; and/or (3) determining that the risk is not (or is) insurable may include determining that the risk is not (or is) insurable in response to determining that the calculated distance is not (or is, respectively) greater than the threshold distance.

The computer-implemented method may include additional, fewer, or alternate actions, such as any of those discussed elsewhere herein. For instance, the method may further include determining that an earthquake moratorium is in effect, and determining that the risk is not (or is) insurable may include comparing the calculated distance to a threshold distance associated with the earthquake moratorium.

The method may include causing a user interface to provide an indication that the risk is not (or is) insurable may include sending the indication that the risk is not (or is) insurable to a computer device associated with a customer, and/or sending the indication that the risk is not (or is) insurable to a computer device associated with an insurance agent. The method may include determining a location of a risk may include receiving application data associated with a request for insurance coverage, where the application data may include an address of a property, and/or determining the location of the risk may further include using the received address to determine a latitude and longitude of a location of the property.

In another aspect, a computer-implemented method may include (1) determining, by one or more processors, that an earthquake moratorium is in effect; (2) receiving, by one or more processors, earthquake location data indicating a latitude and longitude of an epicenter of an earthquake; (3) determining, by one or more processors, a latitude and longitude of a property of a current or potential customer; (4) calculating, by one or more processors, a distance between the latitude and longitude of the epicenter and the latitude and longitude of the property; (5) determining, by one or more processors, whether the property is or is not insurable at least in part by comparing the calculated distance to a threshold distance associated with the earthquake moratorium, and, in response to determining that the property is or is not insurable, causing, by one or more processors, a user interface to provide an indication of whether or not the property is insurable.

The computer-implemented method may include one or more of the following features: (1) receiving earthquake location data indicating a latitude and longitude of the epicenter of the earthquake may include receiving the earthquake location data from a remote server; and/or (2) causing a user interface to provide the indication of whether the property is insurable or not may include sending the indication that the property is insurable or not to one or both of (i) a computer device associated with the current or potential customer, and (ii) a computer device associated with an insurance agent. The computer-implemented method may include additional, fewer, or alternate actions, such as any of those discussed elsewhere herein.

### IX. Exemplary Computer-Readable Medium Embodiments

In another embodiment, a tangible, non-transitory computer-readable medium stores instructions that, when executed by one or more processors, may cause the one or more processors to (1) receive disaster location data indicating a location of a natural disaster; (2) determine a location of a risk or a property; (3) calculate a distance between the location of the natural disaster and the location of the risk or the property; (4) determine whether the risk is insurable at least in part by comparing the calculated distance to a threshold distance, and, when determining that the risk is or is not insurable, cause a user interface to provide an indication that the risk is or is not insurable, respectively.

The tangible, non-transitory computer-readable medium may store instructions that may cause the one or more processors to (1) receive earthquake location data indicating a location of an epicenter of an earthquake; (2) receive earthquake location data indicating a latitude and longitude of the epicenter of the earthquake, determine a latitude and longitude of a location of a property, and calculate a distance between the location of the epicenter and the location of the property using (i) the latitude and longitude of the location of the epicenter and (ii) the latitude and longitude of the location of the property; (3) receive the earthquake location data from a remote server; and/or (4) determine whether the risk is insurable at least in part by determining that the risk is insurable if the calculated distance is greater than the threshold distance, or determining that the risk is not insurable if the calculated distance is not greater than the threshold distance.

The instructions may cause the one or more processors to (a) cause a user interface to provide the indication that the risk is or is not insurable at least in part by sending the indication that the risk is or is not insurable, respectively, to one or both of (i) a computer device associated with a customer, and (ii) a computer device associated with an insurance agent, and/or (b) determine a location of a risk at least in part by receiving application data associated with a request for insurance coverage, the application data including an address of a property, and using the received address to determine a latitude and longitude of a location of the property.

The non-transitory computer-readable medium may store instructions that direct the one or more processors to perform additional, less or alternative functionality, such as any of the functionality discussed elsewhere herein. For instance, the instructions may further cause the one or more processors to determine that an earthquake moratorium is in effect, and may cause the one or more processors to determine whether the risk is insurable at least in part by comparing the calculated distance to a threshold distance associated with the earthquake moratorium.

### X. Additional Considerations

The following additional considerations apply to the foregoing discussion. Throughout this specification, plural instances may implement operations or structures described as a single instance. Although individual operations of one or more methods are illustrated and described as separate operations, one or more of the individual operations may be performed concurrently, and nothing requires that the operations be performed in the order illustrated. These and other variations, modifications, additions, and improvements fall within the scope of the subject matter herein.

Unless specifically stated otherwise, discussions herein using words such as “processing,” “computing,” “calculating,” “determining,” “presenting,” “displaying,” or the like may refer to actions or processes of a machine (e.g., a computer) that manipulates or transforms data represented as physical (e.g., electronic, magnetic, or optical) quantities within one or more memories (e.g., volatile memory, non-volatile memory, or a combination thereof), registers, or other machine components that receive, store, transmit, or display information.

As used herein any reference to “one embodiment” or “an embodiment” means that a particular element, feature, structure, or characteristic described in connection with the embodiment is included in at least one embodiment. The appearances of the phrase “in one embodiment” in various places in the specification are not necessarily all referring to the same embodiment.

As used herein, the terms “comprises,” “comprising,” “includes,” “including,” “has,” “having” or any other variation thereof, are intended to cover a non-exclusive inclusion. For example, a process, method, article, or apparatus that comprises a list of elements is not necessarily limited to only those elements but may include other elements not expressly listed or inherent to such process, method, article, or apparatus. Further, unless expressly stated to the contrary, “or” refers to an inclusive or and not to an exclusive or. For example, a condition A or B is satisfied by any one of the following: A is true (or present) and B is false (or not present), A is false (or not present) and B is true (or present), and both A and B are true (or present).

In addition, use of “a” or “an” is employed to describe elements and components of the embodiments herein. This is done merely for convenience and to give a general sense of the invention. This description should be read to include one or at least one and the singular also includes the plural unless it is obvious that it is meant otherwise.

Alternative examples of the structures and methods illustrated herein may be employed without departing from the principles described herein. Thus, while particular examples and applications have been illustrated and described, it is to be understood that the disclosed examples are not limited to the precise construction and components disclosed herein. Various modifications, changes, and variations may be made in the arrangement, operation and details of the method and apparatus disclosed herein without departing from the spirit and scope defined in the appended claims.

The patent claims at the end of this patent application are not intended to be construed under 35 U.S.C. § 112(f) unless traditional means-plus-function language is expressly recited, such as “means for” or “step for” language being explicitly recited in the claim(s).

1. A computer-implemented method at a server having one or more processors, the method comprising:
receiving, by the one or more processors at the server, from a database via wired or wireless communication, earthquake location data indicating a latitude and a longitude of a location of an epicenter of an earthquake;
receiving, by the one or more processors at the server, from a user via a user interface executing on a user computer via wired or wireless communication, an address of a property;
obtaining, by the one or more processors at the server, from a mapping service, a latitude and a longitude of a location of the property based upon the address of the property;
calculating, by the one or more processors at the server, a distance between the location of the epicenter and the location of the property using (i) the latitude and the longitude of the location of the epicenter and (ii) the latitude and the longitude of the location of the property;
determining, by the one or more processors at the server, a risk level associated with the property from three or more risk levels by comparing the calculated distance to at least a first threshold distance and a second threshold distance different than the first threshold distance; and
causing, by the one or more processors at the server, to send via wired or wireless communication to the software application at the user computer for display in the user interface at the user computer a level of coverage or a cost of coverage for the property based upon the risk level.

2. (canceled)

3. (canceled)

4. The computer-implemented method of claim 1, wherein receiving the earthquake location data indicating the latitude and the longitude of the location of the epicenter of the earthquake includes receiving the earthquake location data from a remote server.

5. The computer-implemented method of claim 1, further comprising:
determining that an earthquake moratorium is in effect; and
determining that the property is not insurable based upon a comparison of the calculated distance to first threshold distance associated with the earthquake moratorium.

6. (canceled)

7. The computer-implemented method of claim 5, further comprising, in response to determining the property is not insurable, causing by the one or more processors at the server, the user interface at the user computer to provide an indication that the property is not insurable rather than the level of coverage or the cost of coverage.

8. (canceled)

9. (canceled)

10. A tangible, non-transitory computer-readable medium storing instructions that, when executed by one or more processors, cause a server to:
receive, at the server from a database via wired or wireless communication, earthquake location data indicating a latitude and a longitude of an epicenter of a location of an earthquake;
receive, at the server from a user of a user interface executing at a user computer via wired or wireless communication, an address of a property;
determine, at the server, a latitude and a longitude of a location of the property based upon the address of the property;
obtain, at the server, from a mapping service, a distance between the location of the epicenter and the location of the property using (i) the latitude and the longitude of the location of the epicenter and (ii) the latitude and the longitude of the location of the property;
select, at the server, a risk level associated with the property from three or more risk levels comparing the calculated distance to at least a first threshold distance and a second threshold distance different than the first threshold distance; and
send, from the server, to the user interface executing at the user computer for display, a level of coverage or a cost of coverage for the property based upon the risk level.

11. (canceled)

12. (canceled)

13. The tangible, non-transitory computer-readable medium of claim 10, wherein the database includes a United States geological survey database.

14. The tangible, non-transitory computer-readable medium of claim 10, wherein the instructions, when executed by the one or more processors, further cause the server to:
determine that an earthquake moratorium is in effect; and
determine whether the property is insurable at least in part by comparing the calculated distance to a third threshold distance associated with the earthquake moratorium.

15. The tangible, non-transitory computer-readable medium of claim 14, wherein the instructions, when executed by the one or more processors, further cause the server to determine whether the property is insurable at least in part by:
determining that the property is insurable if the calculated distance is greater than the first threshold distance; or
determining that the property is not insurable if the calculated distance is not greater than the second threshold distance.

16. The tangible, non-transitory computer-readable medium of claim 14, wherein the instructions, when executed by the one or more processors, further cause the server to cause user interface executing at the user computer to provide the indication that the property is not insurable at least in part by sending an indication that the property is not insurable to one or both of (i) of the user computer associated with a current or a potential customer, and (ii) another user computer associated with an insurance agent.

17. (canceled)

18. A computer-implemented method at a server having one or more processors, the method comprising:
receiving, by the one or more processors at the server, from a database via wired or wireless communication, natural disaster location data indicating a latitude and a longitude of a location of a first portion of a natural disaster, and indicating a latitude and a longitude of a location of a second portion of the natural disaster;
receiving, by the one or more processors at the server, from a user via a user interface executing on a user computer via wired or wireless communication, an address of a property;
determining, by the one or more processors at the server, by obtaining from a mapping service server a latitude and a longitude of a location of the property;
calculating, by the one or more processors at the server, a first distance between the location of the first portion of the natural disaster defined by the latitude and the longitude of the first portion of the natural disaster, and the location of the property defined by the latitude and the longitude of the property;
calculating, by the one or more processors at the server, a second distance between the location of the second portion of the natural disaster defined by the latitude and the longitude of the second portion of the natural disaster, and the location of the property defined by the latitude and the longitude of the property;
determining, by the one or more processors at the server, that the property is insurable at least in part by comparing a minimum of the calculated first distance and the calculated second distance to a threshold distance associated with the natural disaster; and
in response to determining that the property is insurable, causing, by the one or more processors at the server, via wired or wireless communication, the user interface executing at the user computer to provide an indication that the property is insurable.

19. The computer-implemented method of claim 18, wherein receiving the natural disaster location data indicating the latitude and the longitude of the first portion of the natural disaster includes receiving the natural disaster location data from a database at a remote server.

20. The computer-implemented method of claim 18, wherein causing the user interface to provide the indication that the property is insurable includes sending the indication that the property is insurable to one or both of (i) the user computer associated with a current or a potential customer, and (ii) an additional user computer associated with an insurance agent.

21. The computer-implemented method of claim 1, wherein the user computer is associated with at least one of a current or potential customer, or an agent.

22. The computer-implemented method of claim 1, wherein determining the latitude and the longitude of the location of the property includes accessing at least one of a mapping service or a mapping application.

23. The computer-implemented method of claim 1, wherein the database includes a United States geological survey database.

24. The computer-implemented method of claim 18, wherein the first portion of the natural disaster and the second portion of the natural disaster are associated with at least one of a path of a storm and an edge of storm, or different earthquakes.
